(19) United States
(12) Patent Application Publication
(10) Pub. No.: US 2016/0123241 A1
(43) Pub. Date: May 5, 2016

(54) METHOD AND SYSTEM FOR PREVENTING ENGINE STALL UPON SHORTING OF OIL CONTROL VALVE

(71) Applicant: Hyundai Motor Company, Seoul (KR)

(72) Inventors: Jung Sup Byun, Yongin-si (KR); Seong Kyu PARK, Suwon-si (KR)

(73) Assignee: Hyundai Motor Company, Seoul (KR)

(21) Appl. No.: 14/686,032

(22) Filed: Apr. 14, 2015

(30) Foreign Application Priority Data
Oct. 31, 2014 (KR) 10-2014-0150156

(51) Int. Cl. F02D 13/02; F01L 1/344; F02D 35/02

(52) U.S. Cl. CPC F02D 13/02; F02D 35/02; F01L 1/3442; F01L 2001/34426

(57) ABSTRACT

A method for preventing an engine stall upon a short of an oil control valve may include implementing, by a controller, an engine stall prevention control logic for increasing a rotation number of an engine to a set target value when a failure signal number of the oil control valve due to a short thereof exceeds a set reference value.

### CROSS-REFERENCE(S) TO RELATED APPLICATION

The present application claims priority to Korean Patent Application Number 10-2014-0150156 filed Oct. 31, 2014, the entire contents of which is incorporated herein for all purposes by this reference.

### BACKGROUND OF THE INVENTION

1. Field of the Invention

The present invention relates to a method and a system for preventing an engine stall when an oil control valve is shorted to a ground, and more particularly, to a method and a system for preventing an engine stall when an oil control valve is shorted to a ground, the engine being stalled when the oil control valve is settled in an opening state when the oil control valve is shorted to a ground due to an electrical failure and fuel is insufficiently burnt due to an overlap of the valve when a cam is forcibly advanced or retarded.

2. Description of Related Art

Generally, a Continuous Variable Valve Timing (CVVT) unit has been adapted so as to optimize a performance, a fuel ratio and exhaust gas of an engine.

According to a brief of CVVT technology, a cam is rotated to an optimum cam position that is pre-set on a data of Engine Control Unit (ECU) by driving the cam by using an Oil Control Valve (OCV) according to a driving condition of an engine.

Accordingly, the oil control valve is one main component for implementing CVVT.

In more detail, the engine control unit drives the oil control valve to pressurize or depressurize the oil at an oil passage that is connected to the oil control valve and a cam shaft, thereby controlling a cam to be disposed at a desired location.

A CVVT unit is a device for improving a torque decreasing at a low speed and a middle speed and reducing fuel ratio and exhaust gas at a middle speed by varying phase of intake cam or exhaust cam and adjusting overlap of a valve.

Meanwhile, when an opening state of an oil control valve is settled, called as “Open Stuck”, due to an electrical failure of the oil control valve caused from a short thereof, an engine is stalled wherein it will be described referring to FIG. 1.

FIG. 1 is a graph illustrating a phenomenon in which an engine is stalled when an oil control valve is shorted to a ground due to an electrical failure thereof.

As shown in FIG. 1, it is confirmed that as the number of failure signal of an oil control valve is increased consistently after a predetermined time has passed, RPM of an engine is decreased.

When an oil control valve is shorted to a ground due to an electrical failure thereof, the oil control valve is settled in an opening state and the number of failure sensing is increased 1.

At this time, the oil control valve is opened and is advanced or retarded by an intake cam or an exhaust cam thereby to increase an overlap of the valve. Accordingly, an engine is stalled due to an unstable combustion of fuel.

That is, as shown in FIG. 1, the intake cam is moved to a most advance position due to an electrical failure of the oil control valve 2, and as a result RPM of an engine becomes 0 and an engine is stalled 3 due to an unstable combustion of fuel resulted from the increase of an overlap of the valve.

After that, the failure of the oil control valve is completed to be sensed 4 after the engine is stalled.

According to a related art, the number of failure signal due to an electrical failure of an oil control valve is increased significantly and an intake cam is moved to a most advance position before ECU senses the failure, and thus an overlap of the valve is increased. Accordingly, an engine is stalled due to an unstable combustion of fuel and then a failure of an oil control valve is confirmed by ECU.

However, according to the present invention, the engine stall due to an overlap of an valve can be prevent by increasing the rotation number of an engine to a target value when the accumulated number of failure signal exceeds to a set reference value while the sensed number of failure signal caused that an oil control valve is shorted to a ground is increased.

The information disclosed in this Background of the Invention section is only for enhancement of understanding of the general background of the invention and should not be taken as an acknowledgement or any form of suggestion that this information forms the prior art already known to a person skilled in the art.

### BRIEF SUMMARY

Various aspects of the present invention are directed to providing a method and a system for preventing an engine stall in advance when an oil control valve is shorted to a ground, by transmitting a signal, to the engine, for increasing a rotation number of the engine to a set target value when a failure signal number of the oil control valve exceeds a set reference value.

According to various aspects of the present invention, a method for preventing an engine stall upon a short of an oil control valve may include implementing, by a controller, an engine stall prevention control logic for increasing a rotation number of an engine to a set target value when a failure signal number of the oil control valve due to a short thereof exceeds a set reference value.

The engine stall prevention control logic may include determining whether the oil control valve is shorted to a ground, counting a failure number of the oil control valve upon the short thereof, comparing the counted failure number to the reference value, and increasing the rotation number of the engine to the set target value when the counted failure number exceeds the set reference value.

Whether the oil control valve is shorted to the ground may be determined through the controller by an opening time of the oil control valve exceeding the set reference value, or by a short signal from an oil control valve driving circuit for driving the oil control valve.

The counting the failure number of the oil control valve when the oil control valve is shorted to the ground includes accumulating the failure number of the oil control valve after it is determined through the controller that the oil control valve is failed due to the short thereof.

The comparing the counted failure number to the reference value and the increasing the rotation number of the engine to the set target value when the counted failure number exceeds the set reference value may include transmitting a signal, to the engine through the controller, for increasing the rotation number of the engine to the set target value.

The increasing the rotation number of the engine may be ended when the failure signal of the oil control valve is not received by the controller after the increasing the rotation number of the engine to the set target value when the failure number of the oil control valve exceeds the set reference value.

According to various aspects of the present invention, a system for preventing an engine stall upon an open stuck of an oil control valve may include a data storing device receiving information of a driving condition of a vehicle and a short signal of the oil control valve and a counted failure signal number of the oil control valve upon a short thereof, and a controller transmitting, to an engine, a signal for increasing a rotation number of the engine to a target value when the counted failure signal number of the oil control valve exceeds a set reference value.

The controller may end transmitting, to the engine, the signal for increasing the rotation number of the engine when the failure signal of the oil control valve is not received from the storing device after transmitting, to the engine, the signal for increasing the rotation number of the engine to the target value.

It is understood that the term “vehicle” or “vehicular” or other similar terms as used herein is inclusive of motor vehicles in general such as passenger automobiles including sports utility vehicles (SUV), buses, trucks, various commercial vehicles, watercraft including a variety of boats and ships, aircraft, and the like, and includes hybrid vehicles, electric vehicles, plug-in hybrid electric vehicles, hydrogen-powered vehicles and other alternative fuel vehicles (e.g., fuel derived from resources other than petroleum). As referred to herein, a hybrid vehicle is a vehicle that has two or more sources of power, for example, both gasoline-powered and electric-powered vehicles.

The methods and apparatuses of the present invention have other features and advantages which will be apparent from or are set forth in more detail in the accompanying drawings, which are incorporated herein, and the following Detailed Description, which together serve to explain certain principles of the present invention.

### BRIEF DESCRIPTION OF THE DRAWINGS

FIG. 1 is a graph illustrating a phenomenon in which an engine is stalled when an oil control valve is shorted to a ground due to an electrical failure thereof according to a related art.

FIG. 2 is a whole flowchart illustrating an engine stall prevention control logic according to an exemplary embodiment of the present invention.

FIG. 3 is a flowchart illustrating in detail the engine stall prevention control logic at the respective step according to an exemplary embodiment of the present invention.

FIG. 4 is a graph illustrating location variation of a cam and RPM of an engine according to an exemplary embodiment of the present invention.

FIG. 5 is a block diagram illustrating an engine stall prevention system when an opening state of an oil control valve is settled according to an exemplary embodiment of the present invention.

It should be understood that the appended drawings are not necessarily to scale, presenting a somewhat simplified representation of various features illustrative of the basic principles of the invention. The specific design features of the present invention as disclosed herein, including, for example, specific dimensions, orientations, locations, and shapes will be determined in part by the particular intended application and use environment.

### DETAILED DESCRIPTION

Reference will now be made in detail to various embodiments of the present invention(s), examples of which are illustrated in the accompanying drawings and described below. While the invention(s) will be described in conjunction with exemplary embodiments, it will be understood that the present description is not intended to limit the invention(s) to those exemplary embodiments. On the contrary, the invention(s) is/are intended to cover not only the exemplary embodiments, but also various alternatives, modifications, equivalents and other embodiments, which may be included within the spirit and scope of the invention as defined by the appended claims.

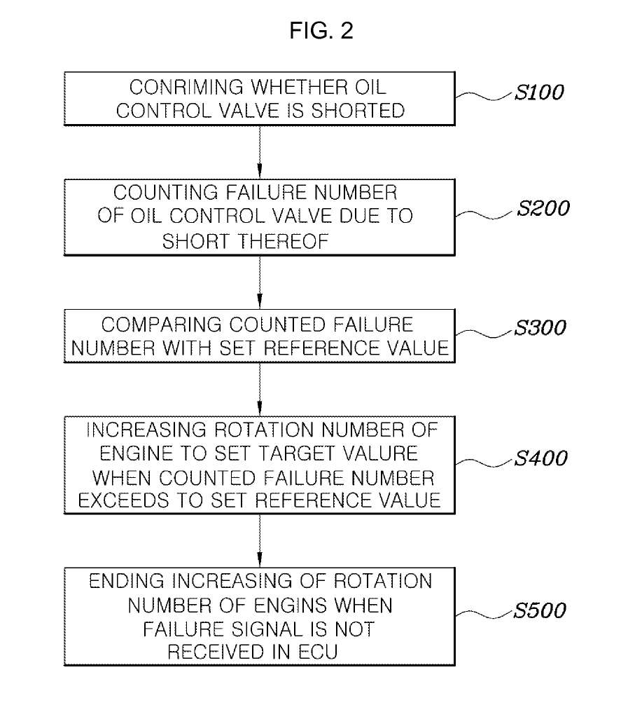

FIG. 2 is a flowchart illustrating an engine stall prevention control logic so as to prevent an engine from being stalled when an oil control valve is shorted to a ground.

An engine stall prevention control logic according to various embodiments of the present invention is featured such that the rotation number of an engine is increased to a target value when the number of failure signals exceeds a set reference value so as to prevent an engine stall when the oil control valve is failed due to a short thereof.

That is, according to a related art, a problem occurs that the number of failure signals caused from an oil control valve which is shorted to a ground is increased significantly and reaches to a predetermined level and an engine is stalled before an ECU senses the failure of the oil control valve. However, according to an exemplary embodiment of the present invention, the number of failure signals, the failure being caused from that oil control valve that is shorted to a ground, is counted and then the rotation number of an engine is increased in advance when the counted number exceeds a set reference value, thereby preventing an engine stall in advance.

In the engine stall prevention control logic a step of determining whether an oil control valve is shorted to a ground S100 is determined by the opening time of the oil control valve due to the short thereof exceeding a set reference value, or a short signal from an oil control valve driving circuit for driving the oil control valve is received by an ECU/controller 200, and in this case it is determined that the oil control valve is shorted to a ground.

Meanwhile, a step S200 of counting the failure number of an oil control valve when the oil control valve is shorted to a ground is performed by accumulating the failure number after determining that the oil control valve is failed due to a short thereof through the ECU.

That is, it is determined that the oil control valve is failed when the oil control valve is opened for a predetermined time (unit time) and the failure number is counted one time, or it is determined that the oil control valve is failed when the short signal of the oil control valve is received for a predetermined time (unit time), and the failure signal number is counted one time, and the accumulated value of failure signal number of the oil control valve is stored continuously.

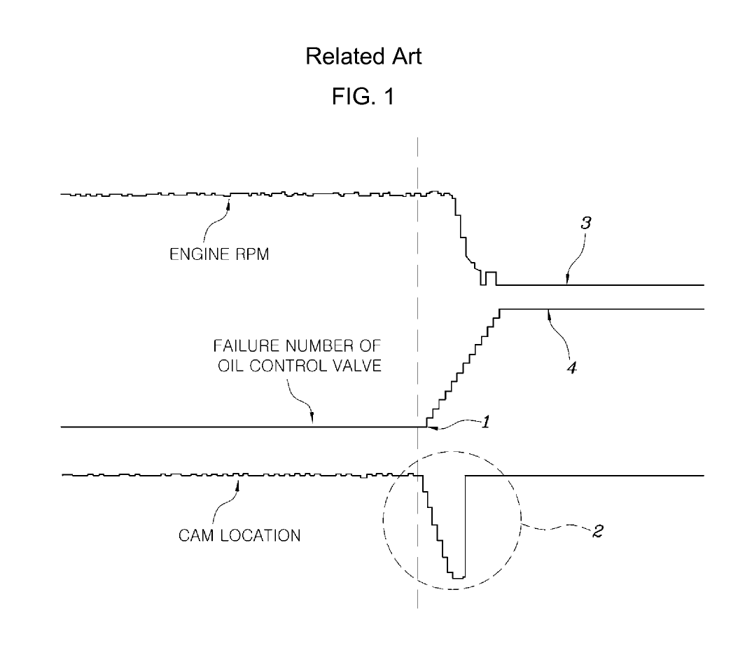

As shown in FIG. 1, the number of the failure signal of the oil control valve is accumulated to increase and the accumulated number is stored in ECU.

Meanwhile, in a step S300 of comparing the failure number of the oil control valve to a set reference value and a step S400 of increasing the rotation number of an engine to a set target value when the failure number exceeds to a set reference value, the ECU transmits a signal for increasing the rotation number of an engine to a set target value to the engine and that ECU determines that the oil control valve is failed due to short when the failure signal numbers are accumulated as 100 times (set target value), and transmits a signal for increasing the rotation number of an engine to a set target value in advance to the engine.

Of course, the target rotation number of an engine may be a variable RPM value and varied variously according to a state of a vehicle and the driving condition.

A signal for allowing the engine to be rotated at a predetermined target RPM is transmitted to the engine by the engine stall prevention control logic when the accumulated number of failure signals, the failure being caused from the oil control valve which is shorted to a ground, exceeds a predetermined reference value (average value of 1-5 times, which may be varied according to air displacement and driving condition of a vehicle), thereby preventing an engine stall caused from that an oil control valve is shorted to a ground) in advance.

Meanwhile, as shown in drawings, when the failure signal is not received further in the ECU/ controller 200 after the step of increasing the rotation number of an engine to a set target value when the failure number of an oil control valve exceeds a set reference value, the step of increasing the rotation number is ended S500.

That is, in a case where an engine stall is prevented by increasing the rotation number of an engine 300 to a set target value and a cam is also deviated from most advance location, when the failure signal of the oil control valve due to a short thereof is not received further in ECU 200, a step of releasing RPM compensation is performed, in which the signal for increasing the rotation number of an engine is not transmitted further to the engine.

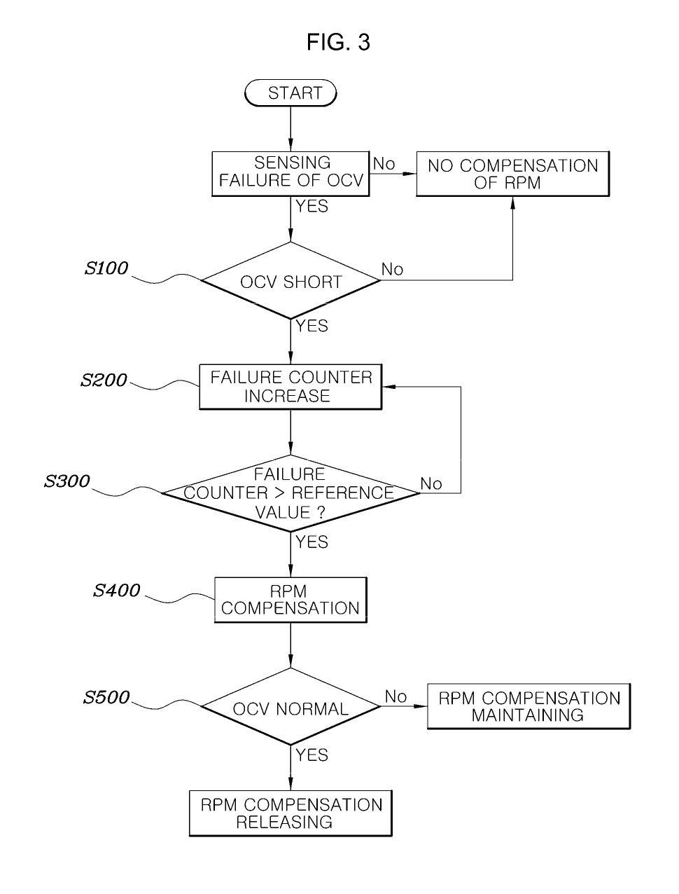

Meanwhile, FIG. 3 is a flowchart illustrating in detail an engine stall prevention control logic at the respective step according to various embodiments of the present invention wherein the operation procedures will be described referring to the drawing.

Firstly, a procedure of determining whether an oil control valve is failed due to a short thereof is performed by the ECU/controller 200, and the ECU 200 does not compensate RPM when it is confirmed that the oil control valve is operated normally or if the oil control valve is not failed due to the short thereof. On the contrary when it is confirmed that the oil control valve is failed due to a short thereof, the ECU 200 performs to count the failure number of the oil control valve.

At this time, when the accumulated failure number of the oil control valve exceeds to a set reference value, ECU performs to compensate RPM for an engine, thereby preventing an engine stall in advance due to a failure caused from that the oil control valve is shorted to a ground, unlike a related art.

After that, when the failure signal of the oil control valve due to a short thereof is not further received in the ECU 200, the step of releasing the RPM compensation is performed, thereby implementing the engine stall prevention control logic according to various embodiments of the present invention.

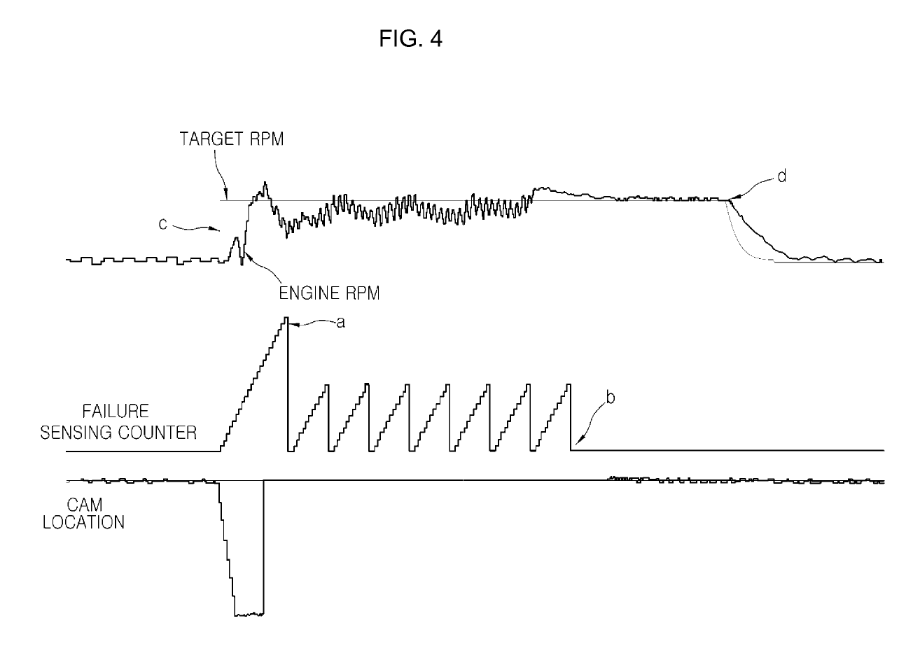

Meanwhile, FIG. 4 is a graph illustrating location variation of a cam and RPM of an engine according to various embodiments of the present invention in which when the failure number of an oil control valve exceeds a set reference value prior to reaching to the moment a when a failure of an oil control valve due to a short thereof is sensed, the ECU 200 transmits a signal for increasing RPM to the engine c prior to the failure sensing moment a.

As a result, even though a phenomenon of “RPM Oscillation” occurs due to an unstable combustion of fuel resulted from the rotation number of the engine being increased to a target RPM, the engine stall can be prevented, unlike a related art.

After that, it is confirmed that when a signal that the oil control valve is recovered to a normal state b is sensed in ECU, the step of releasing RPM compensation for an engine d and the cam is recovered back to a normal state from a most advance location.

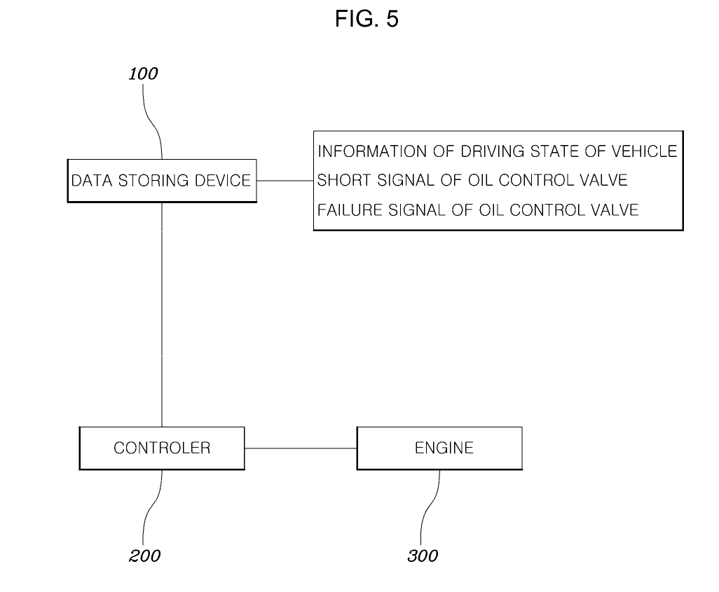

Meanwhile, FIG. 5 is a block diagram illustrating an engine stall prevention system when an opening state of an oil control valve is settled according to various embodiments of the present invention in which the system includes a data storing device 100 and a control unit/controller 200.

The data storing device 100 receives information of the driving condition of a vehicle and a short signal of an oil control valve and counts a failure signal of the oil control valve due to the short thereof, and the control unit/controller 200 transmits a signal for increasing a rotation number of an engine to a target value to the engine 300 when the failure number of an oil control valve that is counted on a basis of the data stored on the data storing device 100 exceeds a set reference value.

Further, the control unit/controller 200 transmits a signal for increasing the rotation number of an engine to the engine 300 to release the step of increasing RPM when the failure signal of an oil control valve is not received from the data storing device 100 after transmitting the signal for increasing the rotation number of an engine to a target value to the engine 300.

More detailed operational procedures are omitted since they are described above.

According to an exemplary embodiment of the present invention, an engine stall is prevented when an oil control valve is failed due to a short thereof, unlike a related art, and thereby the protection of the oil control valve and devices are kept.

The foregoing descriptions of specific exemplary embodiments of the present invention have been presented for purposes of illustration and description. They are not intended to be exhaustive or to limit the invention to the precise forms disclosed, and obviously many modifications and variations are possible in light of the above teachings. The exemplary embodiments were chosen and described in order to explain certain principles of the invention and their practical application, to thereby enable others skilled in the art to make and utilize various exemplary embodiments of the present invention, as well as various alternatives and modifications thereof. It is intended that the scope of the invention be defined by the Claims appended hereto and their equivalents.

What is claimed is:

1. A method for preventing an engine stall upon a short of an oil control valve comprising:
implementing, by a controller, an engine stall prevention control logic for increasing a rotation number of an engine to a set target value when a failure signal number of the oil control valve due to the short thereof exceeds a set reference value.

2. The method for preventing the engine stall upon the short of the oil control valve of claim 1, wherein the engine stall prevention control logic comprises:
determining whether the oil control valve is shorted to a ground;
counting a failure number of the oil control valve upon the short thereof;
comparing the counted failure number to the reference value; and
increasing the rotation number of the engine to the set target value when the counted failure number exceeds the set reference value.

3. The method for preventing the engine stall upon the short of the oil control valve of claim 2, wherein whether the oil control valve is shorted to the ground is determined through the controller by an opening time of the oil control valve exceeding the set reference value, or by a short signal from an oil control valve driving circuit for driving the oil control valve.

4. The method for preventing the engine stall upon the short of the oil control valve of claim 3, wherein the counting the failure number of the oil control valve when the oil control valve is shorted to the ground comprises accumulating the failure number of the oil control valve after the oil control valve is determined, through the controller, to be failed due to the short thereof.

5. The method for preventing the engine stall upon the short of the oil control valve of claim 2, wherein the comparing the counted failure number to the reference value and the increasing the rotation number of the engine to the set target value when the counted failure number exceeds the set reference value comprise transmitting a signal, to the engine through the controller, for increasing the rotation number of the engine to the set target value.

6. The method for preventing the engine stall upon the short of the oil control valve of claim 2, wherein the increasing the rotation number of the engine is ended when the failure signal of the oil control valve is not received by the controller after the increasing the rotation number of the engine to the set target value when the failure number of the oil control valve exceeds the set reference value.

7. A system for preventing an engine stall upon an open stuck of an oil control valve comprising:
a data storing device receiving information of a driving condition of a vehicle and a short signal of the oil control valve and a counted failure signal number of the oil control valve upon a short thereof; and
a controller transmitting, to an engine, a signal for increasing a rotation number of the engine to a target value when the counted failure signal number of the oil control valve exceeds a set reference value.

8. The system for preventing the engine stall upon the open stuck of the oil control valve of claim 7, wherein the controller ends transmitting, to the engine, the signal for increasing the rotation number of the engine when the failure signal of the oil control valve is not received from the storing device after transmitting, to the engine, the signal for increasing the rotation number of the engine to the target value.
